(19) United States
(12) Patent Application Publication
(10) Pub. No.: US 2020/0137029 A1
(43) Pub. Date: Apr. 30, 2020

(54) SECURE CHANNEL FOR CLOUD DEPLOYMENT UNIT

(71) Applicant: Hewlett Packard Enterprise Development LP, Houston, TX (US)

(72) Inventors: Thavamaniraja Sakthievel, Bangalore Karnataka (IN); Vinnarasu Ganesan, Bangalore Karnataka (IN); Siva Subramaniam Manickam, Bangalore Karnataka (IN)

(21) Appl. No.: 16/173,035

(22) Filed: Oct. 29, 2018

(51) Int. Cl. H04L 29/06; H04L 12/26; H04L 12/741

(52) U.S. Cl. CPC H04L 63/0428; H04L 63/083; H04L 45/745; H04L 43/045; H04L 43/062; H04L 63/10

(57) ABSTRACT

In some examples, a method includes receiving access credentials for a deployment unit (DU) of a remote cloud service; and establishing a secure channel with the DU using the access credentials for monitoring of the DU. In some examples, the secure channel is established through the use of an on-demand port forwarding container.

### BACKGROUND

The term “cloud management” can, for example, refer to the management of public and private cloud computing products and services. The term “public cloud” can, for example, refer to a cloud managed by a service provider which can, for example, be accessed via the Internet. Public cloud providers often own and operate infrastructure at a data center to implement a public cloud. The term “private cloud” can, for example, refer to a cloud infrastructure operated for a single organization and may be hosted internally or externally. In “hybrid cloud” environments, cloud resources and data can be managed across multiple domains, which may include multiple public and private cloud domains. Cloud computing customers often rely on one or more third-party cloud management components to help manage their cloud services.

### BRIEF DESCRIPTION OF DRAWINGS

FIG. 1 is a flowchart for a method, according to an example.

FIG. 2 is a diagram of a system, according to an example.

FIG. 3 is a diagram of a system, according to an example.

FIG. 4 is a diagram of a system, according to an example.

FIG. 5 is a diagram of a system, according to an example.

FIG. 6 is a diagram of a computing device, according to an example.

FIG. 7 is a diagram of machine-readable storage medium, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

In some cloud management platforms, there may be a desire to monitor one or more Deployment Units (DUs) of one or more customers. Such DUs can, for example, be monitored for failure analysis or another suitable purpose. For some operations teams, it may be desirable to have a centralized system that can provide monitoring metrics on demand. Although certain open-source cloud monitoring solutions, such as Prometheus™ can provide a federated solution to monitor multiple cloud clusters, monitoring queries through such a federation involves scraping requested data from a target Prometheus server and storing it in a master Prometheus server. This can, in some situations, require a large amount of storage in the master Prometheus server. Moreover, such a request will not be “on demand” and may require a large amount of time to download requested data.

Certain implementations of the present disclosure are directed to a system or method to monitor multiple SaaS-based cloud management platforms using on demand port forwarding containers. Certain implementations can, for example, establish a secure channel between a proposed system and a monitoring service running in a DU. The secure channel can, for example, be established on demand by the system using dynamic port forwarding containers as described in further detail herein.

In some implementations, a method of the present disclosure can include: (a) receiving access credentials for a DU of a remote cloud service and (b) establishing a secure channel with the DU using the access credentials for monitoring of the DU. In some implementations, the secure channel is established through the use of an on-demand port forwarding container. Certain implementations of the present disclosure may provide various advantages over certain existing solutions, including: (1) monitoring of multiple customer DUs on demand, (2) monitoring without consuming additional storage, (3) monitoring metrics and logging information of a cloud management platform with just “one click,” (4) a single pane of glass to see monitoring metrics and logging information of multiple cloud management platform instances, (5) the ability to easily add or delete monitored DUs, (6) detailed monitoring metrics of cloud management platform including cluster, node, and/or Pod-level metrics, and (7) detailed logging analysis. Other advantages of implementations presented herein will be apparent upon review of the description and figures.

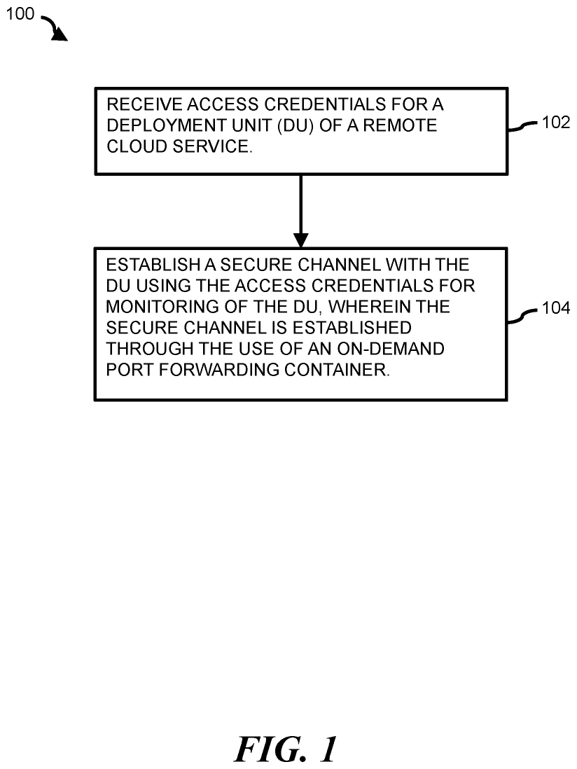

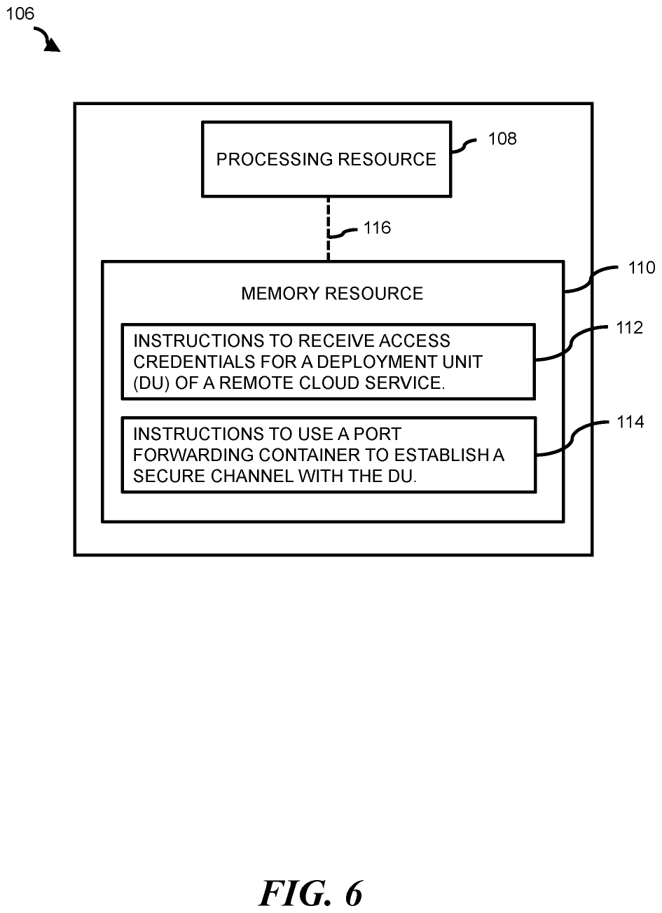

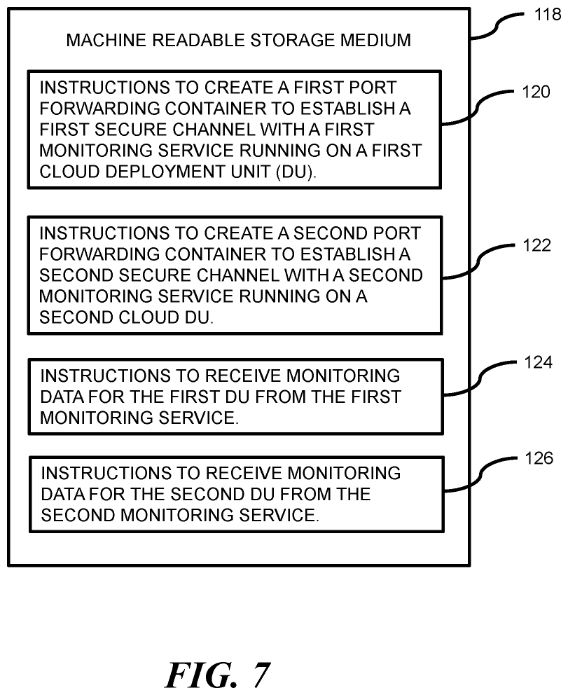

FIG. 1 depicts a flowchart for an example method 100 related to the creation and use of a secure channel for a cloud DU. In some implementations, method 100 can be implemented or otherwise executed through the use of executable instructions stored on a memory resource (e.g., the memory resource of the computing device of FIG. 6), executable machine readable instructions stored on a storage medium (e.g., the medium of FIG. 7), in the form of electronic circuitry (e.g., on an Application-Specific Integrated Circuit (ASIC)), and/or another suitable form. Although the description of method 100 herein primarily refers to steps performed on a server for purposes of illustration, it is appreciated that in some implementations, method 100 can be executed on another suitable computing device. In some implementations, method 100 can be executed on multiple devices in parallel (e.g., in a distributed computing fashion).

Method 100 includes receiving (at block 102) access credentials for a deployment unit (DU) of a remote cloud service. As used herein, the term “deployment unit” can, for example refer to an OpenStack™-powered cloud management instance and associated management services deployed for a given customer. In certain implementations, a given DU is not to be shared between customers, but can, for example, be centrally managed by a cloud management platform.

One component of such a DU can, for example, include an OpenStack or other suitable controller service. Such a controller can, for example, provide cloud management functions for a customer's private cloud instances. Such a function can, for example, be distributed across multiple public cloud instances to allow for scaling out to meet customer resource demands.

Another component of a DU can, for example, include a resource manager service. This service can, for example, tracks and catalog the state of compute, network, and storage resources running in a customer's datacenter and being managed by controllers for the DU. The resource manager service can, for example, work with other DU services to ensure that controllers have a consistent and updated view of managed resources.

Another component of a DU can, for example, include a certificate repository service. Such a service can, for example, be in the form of a per-customer service that provides self-signed certificates that can be used by various services deployed in the DU as well as locally within a customer datacenter for intra-service authentication.

Another component of a DU can, for example, include a log collector in the form of software used to collect logs from a given customer DU and sent to a log analyzer for processing. Another component of a DU can, for example, include a statistics/health agent. Such an agent can, for example, periodically reports status information to a central statistics server and can, for example, be responsible for gathering statistical data for various services/components, including services deployed in the DU deployed for a given customer, deployed Host Agents, deployed Gateways, etc.

Another component of a DU can, for example, include a configuration manager. The configuration manager can, for example, be responsible for installation, configuration, and upgrade of application software deployed both within the DU and on-premise in customer datacenters, which can include services, Host Agents, Gateways, etc. The configuration manager can, for example, be responsible for discovery of customer resources such as hypervisors and gathering of telemetry data regarding these resources.

As provided above, method 100 includes receiving (at block 102) access credentials for a DU. Such access credentials can, for example, be received from a remote account manager associated with the remote cloud service as described in further detail herein.

Method 100 includes establishing (at block 104) a secure channel with the DU using the access credentials received at block 102 for monitoring of the DU. In some implementations, the secure channel can be established through the use of an on-demand port forwarding container. As used herein, the term “container” can, for example, refer to a lightweight, standalone, executable package of software that includes everything needed to run an application including code, runtime, system tools, system libraries and settings. Multiple containers can, for example, run on the same machine and share an Operating System (OS) kernel with other containers, each running as isolated processes.

In some implementations, block 104 includes spawning a container on demand for port forwarding and establishing a secure channel to one or more customer DU instances. In some implementations, the secure channel is to receive monitoring data for the DU without the use of a permanent session. For example, the data can be fetched on demand and no permanent session needs to be established for multiple deployment units.

In some implementations, method 100 includes deleting the port forwarding container when a monitoring query request is completed. In some implementations, the lifespan of the container is only for a particular monitoring report request and the container is deleted after the monitoring report request is completed. In such an implementation, because there are no persistent containers running for a long period of time, database and special storage is not needed to maintain the containers.

In some implementations, the DU can run a monitoring service. The secure channel can interface with the monitoring service to receive monitoring data for the DU. Such monitoring data can, for example, include data relating to overall cluster health, average cluster utilization, Pod-level utilization, Pod detailed metrics, metrics relating to a cloud management platform Application Programming Interface (API), etc.

As used herein, the term “Pod” can, for example, refer to a running process on a cluster. Such a Pod can, for example, encapsulate an application container (or, in some cases, multiple containers), storage resources, a unique network Internet Protocol (IP), and options that govern how the container(s) should run. A Pod can, for example, represent a unit of deployment, such as a single instance of an application in a container management platform such as Kubernetes®, which can, for example, consist of either a single container or a small number of containers that are tightly coupled and that share resources.

In some implementations block 104 can include: (1) using a “kubectl” port forwarding feature (i.e., secure channel) to establish a connection from a remote client to a Prometheus service running on a Kubernetes cluster; (2) identifying the port to be used from the free pool on the client machine; and (3) creating an on demand container for the port forwarding channel for the multiple Kubernetes cluster.

In some implementations, the access credentials are a first set of access credentials, the DU is a first DU, the remote cloud service is a first remote cloud service, the secure channel is a first secure channel, and the port forwarding container is a first port forwarding container. In some implementations, method 100 includes receiving a second set of access credentials for a second DU of a second remote cloud service and establishing a second secure channel with the second DU using the second set of access credentials for monitoring of the second DU. In such an implementation, the second secure channel can be established through the use of a second on-demand port forwarding container. In such an implementation, the first and second secure channels are to receive monitoring data from their respective DUs.

In some implementations, method 100 includes displaying the monitoring data received from the first and second secure channels. The displayed monitoring data can, for example, include an interface that allows a user the ability to view Node level performance metrics, detailed logging information, filtered ERROR logs, HTTP Error codes, Pod-level logging information.

In some implementations, the on-demand port forwarding container dynamically chooses a new available port for each monitoring query, as described in further detail herein. In some implementations, the secure channel is established through the use of a command provided to a container-orchestration system that creates a data connection from a remote client to a cloud service.

It is appreciated that one or more operations of method 100 can be performed periodically. For example, in some implementations, one or more of blocks 102 and 104 (or other operations described herein) may be performed periodically. The various period times for blocks 102 and 104 (or other operations described herein) may be the same or different times. For example, in some implementations, the period of block 102 is every 2 minutes and the period of block 104 is every 5 minutes. It is further appreciated, that the period for a given block may be regular (e.g., every 1 minute) or may be irregular (e.g., every 1 minute during a condition, and every 2 minutes during a second condition). In some implementations, one or more of block 102 and 104 (or other operations described herein) may be non-periodic and may be triggered by some event.

Although the flowchart of FIG. 1 shows a specific order of performance, it is appreciated that this order may be rearranged into another suitable order, may be executed concurrently or with partial concurrence, or a combination thereof. Likewise, suitable additional and/or comparable steps may be added to method 100 or other methods described herein in order to achieve the same or comparable functionality. In some implementations, one or more steps are omitted. For example, in some implementations, block 102 of receiving access credentials can be omitted from method 100 or performed by a different device. It is appreciated that blocks corresponding to additional or alternative functionality of other implementations described herein can be incorporated in method 100. For example, blocks corresponding to the functionality of various aspects of implementations otherwise described herein can be incorporated in method 100 even if such functionality is not explicitly characterized herein as a block in method 100.

Various example implementations for the present disclosure will now be described. It is appreciated that these examples may include or refer to certain aspects of other implementations described herein (and vice-versa), but are not intended to be limiting towards other implementations described herein. Moreover, it is appreciated that certain aspects of these implementations may be applied to other implementations described herein.

Certain implementations of the present disclosure are directed to a system or method to monitor multiple SAAS based cloud management platform using on demand port forwarding containers. Certain implementations can provide a system to monitor multiple customer deployment units on demand and without consuming any additional storage. This can, for example, be achieved by establishing a secure channel between a proposed system and a monitoring service running in a DU. The secure channel can, for example, be established on demand by the system using dynamic port forwarding containers.

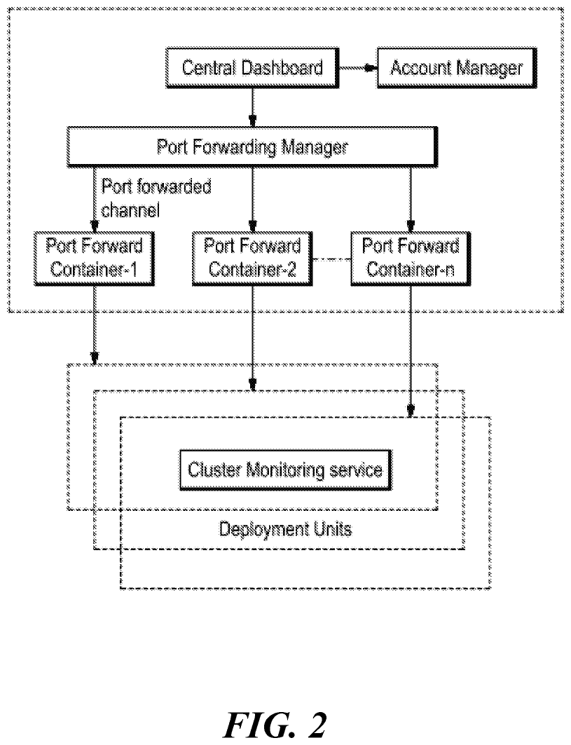

Certain implementations of the present disclosure can include a central dashboard (e.g., FIG. 2). Such a dashboard can allow for presentation of on demand monitoring metrics. The dashboard may also provide a user interface that allows a user to select a desired DU and to provide access credentials. Certain implementations of the present disclosure can include an account manager, which can be in the form of a component of SAAS portal which provides access credentials.

Certain implementations of the present disclosure can include a port forwarding manager. Such a port forwarding manage can create a dynamic port forwarding container on demand whenever a user requests for monitoring metrics for any customer deployment unit. Such a port forwarding container can, for example, be used to establish a secured connection with a monitoring service running on a customer DU.

In some implementations of the present disclosure, a system can be designed to allow an Operations Engineer to select any DU in the central dashboard. The central dashboard can then request access credentials from an account manager for the DU. The central dashboard can then provide the access credentials to a port forwarding manager to initiate a secure channel. The port forwarding manager can then create a secure channel by deploying port forwarding container. In some implementations, for every monitoring query, a new available port can be chosen dynamically. A container can then be spawned which creates a secure port forwarding channel using the chosen port. In some implementations, the container will stay alive until the query request is completed. The central dashboard can then display the DU monitoring metrics based on the query response. In some implementations, there is no aggregation of data involved in the central system and there is no need for any extra storage, which can, for example, makes the system very light weight and can allow the system to be deployed anywhere. Certain implementations of the present disclosure can provide monitoring metrics in a single pane of glass to assist operations team with performing analysis across various customer deployments.

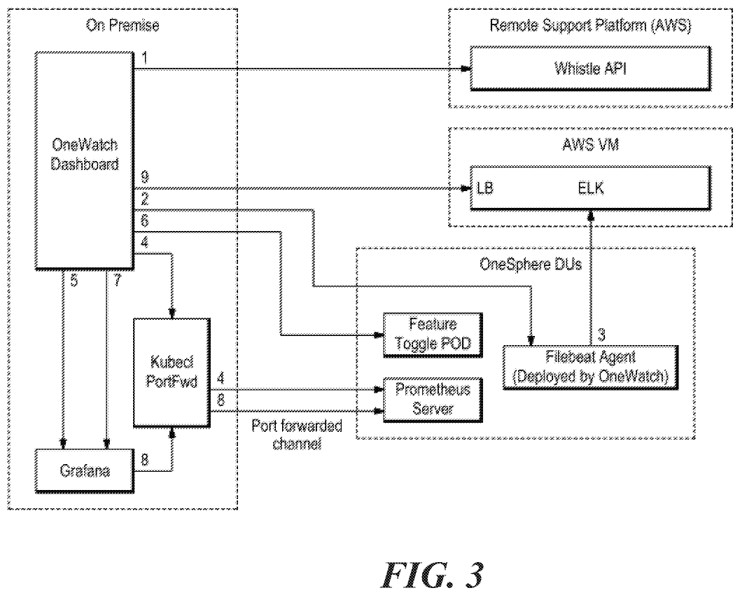

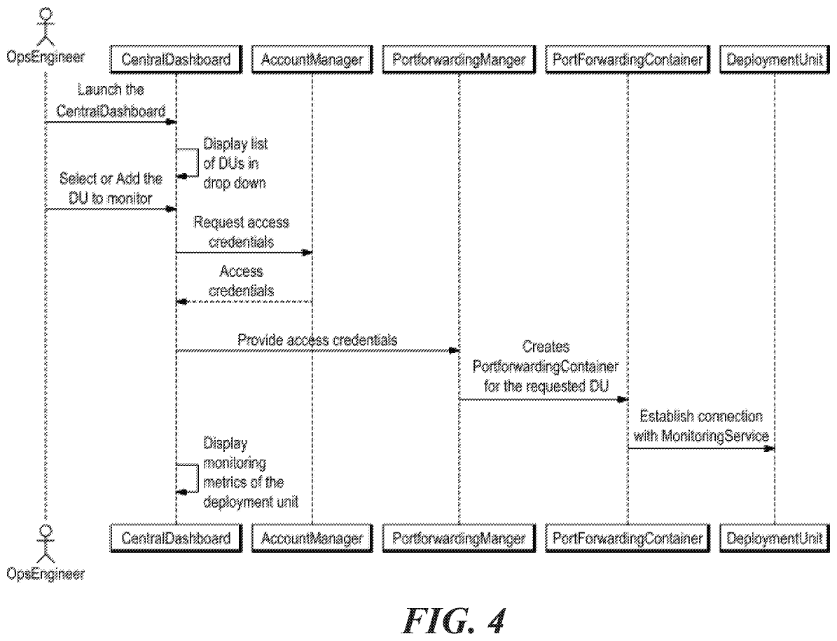

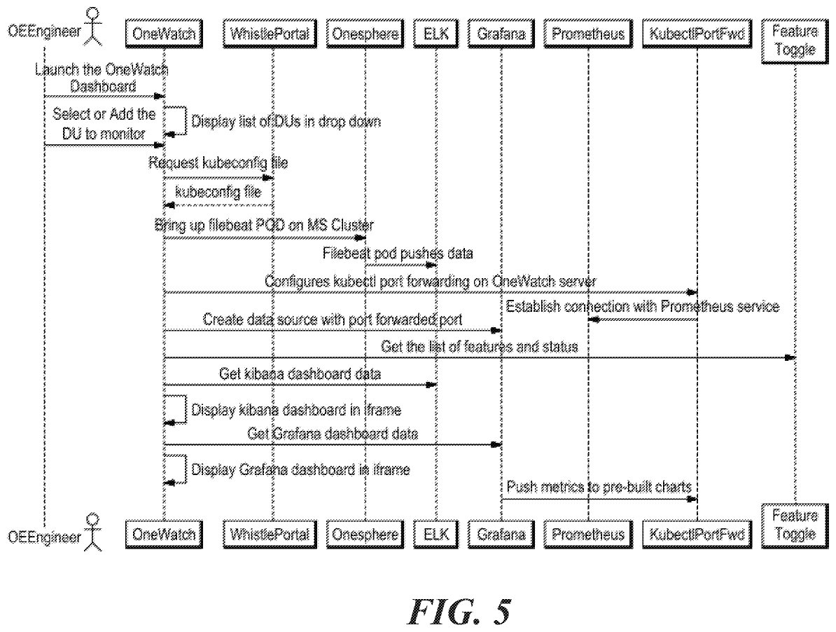

FIG. 3 provides a diagram of an example system according to a non-limiting implementation of the present disclosure. Various aspects of this diagram will be described. The example system is referred to herein as “OneWatch”. FIGS. 4 and 5 illustrate diagrams of exchanges and responsibilities between various components of example systems.

With reference to FIG. 3, “KubectlPortFwd” refers to a module to bring up a Kubectl port forwarding container in OneWatch server runtime. This act as port forwarding channel between Grafana and Prometheus. “ELK” is the acronym for three open source projects: Elasticsearch, Kibana and logstash. Elasticsearch is a search and analytics engine. Kibana lets users visualize data with charts and graphs in Elasticsearch. ELK are components of the OneWatch framework that run on an AWS Virtual Machine (VM).

With further reference to FIG. 3, Filebeat agent is a log data shipper. OneWatch brings up Filebeat agent as a POD in the kube-system namespace of MS Cluster. Filebeat monitors the log files of OneSphere cluster and forwards them to Elasticsearch. OneWatch talks to Whistle portal and download the Kubeconfig file of DU. Kubeconfig contains username, token and certificate that will be used to talk to MS Cluster to: (1) bring up the Filebeat POD, (2) talk to feature toggle POD to get the list of features and its status, (3) communicate with Prometheus through port forwarding, and (4) get the DU details like GIT-SHA and AMI version. Kubeconfig is stored in OneWatch server locally. Filebeat-kubernetes.yml is a static file used to bring up the Filebeat POD on the MS Cluster. The file contains the Load balancer IP address (configured for ELK stack instance running on AWS), username and the password for accessing the Elasticsearch and Kibana services (nginx username and password). The file is locally stored in OneWatch server to bring up the Filebeat POD on the MS Cluster selected.

Monitoring data includes data in motion (i.e., not stored). Whenever the Grafana dashboard is loaded, it queries the data from Prometheus with help of kubectl port forwarding. Log data is provided by the Filebeat agent POD running in MS Cluster, which pushes the logging information to Elasticsearch running on AWS VM through load balancer. Communication from Filebeat to Elasticsearch is through https. Log data in Elasticsearch is provided by Elasticsearch running in AWS, which stores the log data in the file system in the form of indices (databases). Log data in Kibana is provided by Kibana, which allows users to visualize data stored in Elasticsearch with charts and graphs.

With further reference to FIG. 3, Interface 1 relies on the Internet via the HTTPS network protocol. The requestor is OneWatch and the request is: Get Kubeconfig file. The request credentials are Whistle Portal creds with a request authorization of read only. The listener is Whistle Portal, with a response of OneSphere-DU Kubeconfig file using response credentials certificate. In this operation, OneWatch pulls the Kubeconfig file of OneSphere DU.

Interface 2 relies on the Internet via the HTTPS network protocol. The requestor is OneWatch and the request is: kubectl commands. The request credentials are Keystone token with a request authorization of Authorization scope is defined in Kubeconfig file. The listener is Kubernetes, with a response of Response to commands using response credentials certificate. In this operation, Kubectl talks to Kubernetes API to create pod. With the Kubeconfig, OneWatch has full admin access to the Kubernetes cluster.

Interface 3 relies on the Internet via the HTTPS network protocol. The requestor is Filebeat Agent POD and the request is: Push log information to Elasticsearch. The request credentials are nginx creds with a request authorization of write. The listener is Elasticsearch, with a response of Status using response credentials certificate. In this operation, Filebeat Agent POD pushes the data to Elasticsearch.

Interface 4 relies on the local host via the HTTP network protocol. The requestor is OneWatch and the request is: kubectl commands. The request credentials are Keystone token with a request authorization of Authorization scope is defined in Kubeconfig file. The listener is Kubernetes, with a response of Response to commands using response credentials certificate. In this operation, OneWatch configures port forwarding which establish connection with Prometheus running on OneSphere.

Interface 5 relies on the localhost via the HTTP network protocol. The requestor is OneWatch and the request is: Configure Grafana Dashboard. The request credentials are nginx creds with a request authorization of read/write. The listener is Grafana, with a response of Status using response credentials “None.” In this operation, OneWatch configures data source with portforwarded port in Grafana.

Interface 6 relies on the Internet via the HTTPS network protocol. The requestor is OneWatch and the request is: Get the feature list. The request credentials are Kubeconfig with a request authorization of Authorization scope is defined in Kubeconfig file. The listener is feature toggle POD in MS Cluster, with a response of Status using response credentials certificate. In this operation, OneWatch calls the feature toggle service API to get the list of features and its status whenever OneWatch dashboard loads.

Interface 7 relies on the localhost via the HTTP network protocol. The requestor is OneWatch and the request is: Iframe to Grafana dashboard. The request credentials are Grafana password with a request authorization of read/write. The listener is Grafana, with a response of Status using response credentials “None.” In this operation, When the OneWatch dashboard loads it brings up the embedded Grafana dashboard using iframe.

Interface 8 relies on the Internet via the HTTPS network protocol. The requestor is Grafana and the request is: Get metrics. The request credentials are Kubeconfig with a request authorization of Authorization scope is defined in Kubeconfig file. The listener is Prometheus, with a response of Status using response credentials certificate via kubectlPortFwd.

Interface 9 relies on the Internet via the HTTPS network protocol. The requestor is OneWatch and the request is: Iframe to Kibana dashboard. The request credentials are Kibana password with a request authorization of read/write. The listener is Kibana, with a response of Status using response credentials certificate. In this operation, When the OneWatch dashboard loads, it brings up the embedded Kibana dashboard using iframe with load balance IP

Interface 10 relies on the Network name via the Network protocol network protocol. The requestor is Requestor and the request is: Request. The request credentials are Request credentials with a request authorization of Request authorization. The listener is Listener, with a response of Response using response credentials Response credentials.

In this system, log collection is performed via the Logging service and is viewable by authorized log reviewers. Kubeconfig is used for authentication for a cloud management platform. For accessing Monitoring and Logging dashboard, authentication is through nginx. Admin and non-admin roles are indicated in session tokens passed with each request. Containers/VMs provide isolation preventing unauthorized access to files. Separate process types use separate user/group definitions and use appropriate file system controls. IPtables or Security Groups ensure that no unneeded ports are open. The example system can, for example, run on an on-premise bare metal server. Network connections over the Internet are protected via HTTPS. Unencrypted local traffic (such as Dashboard to Grafana) is bound to a localhost server.

FIG. 6 is a diagram of a computing device 106 in accordance with the present disclosure. Computing device 106 can, for example, be in the form of a server or another suitable computing device. As described in further detail herein, computing device 106 includes a processing resource 108 and a memory resource 110 that stores machine-readable instructions 112 and 114.

Instructions 112 stored on memory resource 110 are, when executed by processing resource 108, to cause processing resource 108 to receive access credentials for a DU of a remote cloud service. Instructions 112 can incorporate one or more aspects of blocks of method 100 or another suitable aspect of other implementations described herein (and vice versa). Instructions 114 stored on memory resource 110 are, when executed by processing resource 108, to cause processing resource 108 to use a port forwarding container to establish a secure channel with the DU. Instructions 114 can incorporate one or more aspects of blocks of method 100 or another suitable aspect of other implementations described herein (and vice versa). In some implementations, certain instructions stored on memory resource 110 are, when executed by processing resource 108, to cause processing resource 108 to receive monitoring data for the DU from a monitoring service running on the DU. Such instructions can incorporate one or more aspects of blocks of method 100 or another suitable aspect of other implementations described herein (and vice versa).

Processing resource 108 of computing device 106 can, for example, be in the form of a central processing unit (CPU), a semiconductor-based microprocessor, a digital signal processor (DSP) such as a digital image processing unit, other hardware devices or processing elements suitable to retrieve and execute instructions stored in memory resource 110, or suitable combinations thereof. Processing resource 108 can, for example, include single or multiple cores on a chip, multiple cores across multiple chips, multiple cores across multiple devices, or suitable combinations thereof. Processing resource 108 can be functional to fetch, decode, and execute instructions as described herein. As an alternative or in addition to retrieving and executing instructions, processing resource 108 can, for example, include at least one integrated circuit (IC), other control logic, other electronic circuits, or suitable combination thereof that include a number of electronic components for performing the functionality of instructions stored on memory resource 110. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Processing resource 108 can, for example, be implemented across multiple processing units and instructions may be implemented by different processing units in different areas of computing device 106.

Memory resource 110 of computing device 106 can, for example, be in the form of a non-transitory machine-readable storage medium, such as a suitable electronic, magnetic, optical, or other physical storage apparatus to contain or store information such as machine-readable instructions 112 and 114. Such instructions can be operative to perform one or more functions described herein, such as those described herein with respect to method 100 or other methods described herein. Memory resource 110 can, for example, be housed within the same housing as processing resource 108 for computing device 106, such as within a computing tower case for computing device 106 (in implementations where computing device 106 is housed within a computing tower case). In some implementations, memory resource 110 and processing resource 108 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, memory resource 110 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Memory resource 110 can be in communication with processing resource 108 via a communication link 116. Each communication link 116 can be local or remote to a machine (e.g., a computing device) associated with processing resource 108. Examples of a local communication link 116 can include an electronic bus internal to a machine (e.g., a computing device) where memory resource 110 is one of volatile, non-volatile, fixed, and/or removable storage medium in communication with processing resource 108 via the electronic bus.

In some implementations, one or more aspects of computing device 106 can be in the form of functional modules that can, for example, be operative to execute one or more processes of instructions 112 or 114 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of computing device 106 can, for example, include one or more machine-readable storage mediums and one or more computer processors.

In view of the above, it is appreciated that the various instructions of computing device 106 described above can correspond to separate and/or combined functional modules. For example, instructions 112 can correspond to an “access credentials receiving module” to receive access credentials for a DU of a remote cloud service. Likewise, instructions 114 can correspond to a “secure channel establishing module” to establish a secure channel with the DU using the access credentials for monitoring of the DU. It is further appreciated that a given module can be used for multiple functions. As but one example, in some implementations, a single module can be used to both receive access credentials (e.g., corresponding to the functionality of instructions 112) as well as to establish a secure channel (e.g., corresponding to the functionality of instructions 114).

FIG. 7 illustrates a machine-readable storage medium 118 including various instructions that can be executed by a computer processor or other processing resource. In some implementations, medium 118 can be housed within a server or another suitable computing device. For illustration, the description of machine-readable storage medium 118 provided herein makes reference to various aspects of computing device 106 (e.g., processing resource 108) and other implementations of the disclosure (e.g., method 100). Although one or more aspects of computing device 106 (as well as instructions such as instructions 112 and 114) can be applied to or otherwise incorporated with medium 118, it is appreciated that in some implementations, medium 118 may be stored or housed separately from such a system. For example, in some implementations, medium 118 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 118 includes machine-readable instructions 120 stored thereon to cause processing resource 108 to create a first port forwarding container to establish a first secure channel with a first monitoring service running on a first cloud deployment unit (DU). Instructions 120 can, for example, incorporate one or more aspects of block 104 of method 100 or another suitable aspect of other implementations described herein (and vice versa). Medium 118 includes machine-readable instructions 122 stored thereon to cause processing resource 108 to create a second port forwarding container to establish a second secure channel with a second monitoring service running on a second cloud DU. Instructions 122 can, for example, incorporate one or more aspects of block 104 of method 100 or another suitable aspect of other implementations described herein (and vice versa).

Medium 118 includes machine-readable instructions 124 stored thereon to cause processing resource 108 to receive monitoring data for the first DU from the first monitoring service. Instructions 124 can, for example, incorporate one or more aspects method 100 or another suitable aspect of other implementations described herein (and vice versa). Medium 118 includes machine-readable instructions 126 stored thereon to cause processing resource 108 to receive monitoring data for the second DU from the second monitoring service. Instructions 126 can, for example, incorporate one or more aspects of method 100 or another suitable aspect of other implementations described herein (and vice versa).

In some implementations, medium 118 can include machine-readable instructions stored thereon to cause processing resource 108 to display monitoring data for the first and second DU on a single dashboard. Such instructions can, for example, incorporate one or more aspects of method 100 or another suitable aspect of other implementations described herein (and vice versa).

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

What is claimed is:

1. A method comprising:
receiving access credentials for a deployment unit (DU) of a remote cloud service; and
establishing a secure channel with the DU using the access credentials for monitoring of the DU,
wherein the secure channel is established through the use of an on-demand port forwarding container.

2. The method of claim 1,
wherein the DU runs a monitoring service, and
wherein the secure channel is to interface with the monitoring service to receive monitoring data for the DU.

3. The method of claim 1, wherein the access credentials are received from a remote account manager associated with the remote cloud service.

4. The method of claim 1, wherein the access credentials are a first set of access credentials, the DU is a first DU, the remote cloud service is a first remote cloud service, the secure channel is a first secure channel, and the port forwarding container is a first port forwarding container, further comprising:
receiving a second set of access credentials for a second DU of a second remote cloud service; and
establishing a second secure channel with the second DU using the second set of access credentials for monitoring of the second DU,
wherein the second secure channel is established through the use of a second on-demand port forwarding container, and
wherein the first and second secure channels are to receive monitoring data from their respective DUs.

5. The method of claim 4, further comprising:
displaying the monitoring data received from the first and second secure channels.

6. The method of claim 1, wherein the on-demand port forwarding container dynamically chooses a new available port for each monitoring query.

7. The method of claim 1, further comprising:
deleting the port forwarding container when a monitoring query request is completed.

8. The method of claim 1, wherein the secure channel is to receive monitoring data for the DU without the use of a permanent session.

9. The method of claim 1, wherein the secure channel is to receive monitoring data for the DU in the form of cluster, node, and/or pod-level metrics.

10. The method of claim 1, wherein the secure channel is established through the use of a command provided to a container-orchestration system that creates a data connection from a remote client to a cloud service.

11. The method of claim 1, wherein the method does not rely on central storage.

12. A non-transitory machine readable storage medium having stored thereon machine readable instructions to cause a computer processor to:
create a first port forwarding container to establish a first secure channel with a first monitoring service running on a first cloud deployment unit (DU);
create a second port forwarding container to establish a second secure channel with a second monitoring service running on a second cloud DU;
receive monitoring data for the first DU from the first monitoring service; and
receive monitoring data for the second DU from the second monitoring service.

13. The medium of claim 12, wherein the medium readable instructions are to cause a computer processor to:
display monitoring data for the first and second DU on a single dashboard.

14. A system comprising:
a processing resource; and
a memory resource storing machine readable instructions to cause the processing resource to:
receive access credentials for a deployment unit (DU) of a remote cloud service; and
use a port forwarding container to establish a secure channel with the DU.

15. The system of claim 14, wherein the memory resource is to cause the processing resource to receive monitoring data for the DU from a monitoring service running on the DU.
